(19) United States
(12) Patent Application Publication
(10) Pub. No.: US 2003/0231674 A1
(43) Pub. Date: Dec. 18, 2003

(54) Laser diode

(76) Inventors: Akira Kaneko, Tokyo (JP); Keizo Takemasa, Tokyo (JP)

Correspondence Address: KANESAKA & TAKEUCHI, 1423 Powhatan Street, Alexandria, VA, 22314, US

(21) Appl. No.: 10/435,596

(22) Filed: May 12, 2003

(30) Foreign Application Priority Data
Jun. 14, 2002 (JP) 2002-174835

(51) Int. Cl. H01S 3/04; H01S 3/08

(52) U.S. Cl. 372/36

(57) ABSTRACT

A laser diode chip (110) is placed in the vicinity of the center of a sub-mount (120) under the condition that the distance (b) between an edge on an output side of the sub-mount (120) and the front face of the laser diode chip (110) meets the formula, (b)<(a)/tan(θ/2), wherein the (a) is the distance between the upper surface of the sub-mount (120) and the lower surface of an active layer (140) of the laser diode chip (110) and the θ is the angle of the spread in the vertical direction of the laser beam emitted from the active layer (140).

### BACKGROUND OF THE INVENTION

1. Field of the Invention

This invention relates to a laser diode which has a chip mounted with a sub-mount and, especially, to a connection position of the chip and a shape of the sub-mount.

2. Description of the Related Art

A laser diode emits a laser beam from a side surface of a chip. The laser diode is so designed that an electron having negative charge and a hole having positive charge are recombined in an active layer of the laser diode by applying an electric current to emit the laser beam. When the temperature rises, the energies of the electron and hole become so high that the time period when the electron and hole stay in the active layer is shortened, thereby reducing output of the laser beam. Accordingly, it is important to increase the heat radiation efficiency of the laser diode chip.

There are two methods of connecting the laser diode chip; one is to directly connect the chip to a package body (a header) and the other is to connect it using a sub-mount. A soldering material, such as indium (In), lead tin (PbSn), gold tin (AuSn), gold silicon (AuSi), is used for the connection. The direct connection method is simple, however, it requires precise process for a chip mount surface, and only a soft In soldering material can be used to avoid the thermal stress caused by difference of the coefficient of thermal expansion between the package material and the chip.

The sub-mount used in the sub-mount method acts as a buffer to prevent the break or damage of the chip caused by the difference of the coefficient of thermal expansion between the laser diode chip and the header. Accordingly, a material, such as silicon (Si), silicon carbide (SiC), diamond, beryllium oxide (BeO), copper tungsten (CuW), aluminum nitride (AlN), or boron nitride (CBN), which has a high thermal conductivity and a coefficient of thermal expansion close to that of the chip, and is suitable for precise process, is used for the sub-mount.

In a junction-down method, the side of a p-n junction is connected to a radiating body, and in a junction-up method, the side of a p-n junction is spaced from the radiating body. The junction-down method requires a difficult assembly work because the p-n junction is close to the soldering material. However, it has superior radiating property and is suitable for such an application as a high-power laser which operates under high electrical current. The junction-up method is inferior in the thermal radiating property, but requires no difficult connection work for the chip and provides a low stress at the junction area so that it is suitable for such an application as a laser which operates under a relatively low electrical current.

FIG. 8(a) shows a laser diode chip mounted according to a conventional method and consists of a laser diode chip 1, a sub-mount 2, and a header 3. FIG. 8(b) shows the sub-mount 2 viewed from an emitting direction of the laser diode where the laser diode is mounted by the junction-down method. FIG. 8(c) is a side view of the sub-mount 2 showing a spread 5 of laser beam from a light emitting section. The sub-mount 2 has a shape of rectangular parallelepiped which has a superior process property.

To mount, the laser diode chip 1 is bonded to the sub-mount 2, then the sub-mount 2 with the chip 1 is mounted on the header 3, and the other electrode of the laser diode is wire-bonded to an electric lead of the header 3. The wire-bonding is performed by hermocompression bonding or ultrasonic bonding with an Au- or Al-wire having a diameter of 25 μm. When electrical current is applied, the laser diode chip 1 emits a laser beam.

Where the laser diode chip 1 is mounted as shown in FIG. 8(a), the junction-down method is suitable to efficiently conduct the heat produced in the active layer, and the active layer 4 is disposed on the side of the sub-mount 2. The laser beam emitted from the active layer 4 spreads approximately ±20 degrees in the vertical direction and ±5 to ±10 degrees in the horizontal direction. In FIG. 8(c), the front face of the laser diode chip 1, the end face of the sub-mount 2, and the end face of the header 3 are disposed substantially in a plane so that the spread beam enters a lens or optical fiber efficiently without any loss. In addition, disposing the ends in a plane makes the mount work easy and the distance between the laser diode and an opposed lens substantially constant.

In the above mounting method, however, the temperature of the front face area of the laser diode chip 1 becomes higher than that of the other area because the end face of the sub-mount 2 on the side of the front face of the laser diode chip 1 has only a small radiation area. FIG. 9 shows the thermal conduction between the laser diode 1 and the sub-mount 2. As shown FIG. 9, the thermal conduction on the side of the front face of the laser diode chip 1 is lower than that of the other area so that the heat radiation of the laser diode chip 1 becomes worse as the temperature of the laser diode chip 1 rises. In FIG. 10, the light output of a high-power laser diode module is saturated in the range of high electric current due to adverse effects of the heat generated in the chip.

### BRIEF SUMMARY OF THE INVENTION

Accordingly, it is an object of the invention to provide a laser diode capable of minimizing the saturation of the light output caused by the heat generation in the chip by increasing the heat radiation efficiency without any output loss of the laser diode.

According to one aspect of the invention, a laser diode comprises a header, a sub-mount provided on an upper surface of the header, and a laser diode chip provided in the vicinity of a center of and on an upper surface of the sub-mount.

For example, the laser diode chip is provided on the surface of the sub-mount such that a distance (b) between an edge on an output side of the sub-mount and a front face of the laser diode chip meets the formula, (b)<(a)/tan(θ/2), wherein the (a) is a distance between an upper surface of the sub-mount and a lower surface of an active layer of the laser diode chip and the θ is an angle of a spread in a vertical direction of a laser beam emitted from the active layer.

It is preferable that a portion of the sub-mount in front of the front face of the laser diode chip is made tapered or depressed.

It is also preferable that the sub-mount is provided on an upper surface of the header in the vicinity of a center of the header.

### BRIEF DESCRIPTION OF THE DRAWINGS

FIG. 1(a) is a perspective view of a sub-mount with a laser diode chip according to the first embodiment of the invention.

FIG. 1(b) is a side view of the sub-mount with the laser diode chip of FIG. 1(a).

FIG. 2 is an enlarged side view of a light output section of the laser diode chip.

FIG. 3 is a side view showing thermal conduction between the laser diode chip and the sub-mount according to the first embodiment.

FIG. 4(a) is a perspective view of a sub-mount with a laser diode chip according to the second embodiment of the invention.

FIG. 4(b) is a side view of the sub-mount with the laser diode chip of FIG. 4(a).

FIG. 5(a) is a perspective view of a sub-mount with a laser diode chip according to the third embodiment of the invention.

FIG. 5(b) is a side view of the sub-mount with the laser diode chip of FIG. 5(a).

FIG. 6(a) is a perspective view of a laser diode according to the fourth embodiment of the invention.

FIG. 6(b) is a sectional view of the laser diode of FIG. 1(a) taken along line 6-6 of FIG. 6(a).

FIG. 7 is a graph showing the light output vs the input electric current, of laser diodes according to each of the first, second, and third embodiments and the fourth embodiment coupled with the third embodiment of the invention, and the prior art.

FIG. 8(a) is a perspective view of a laser diode according to the prior art.

FIG. 8(b) is a front view of a sub-mount and a laser diode chip of FIG. 8(a) viewed from an emitting direction of the laser diode.

FIG. 8(c) is a side view of the sub-mount and the laser diode chip of FIG. 1(a).

FIG. 9 is a side view showing thermal conduction between the laser diode chip and the sub-mount according to the prior art.

FIG. 10 is a graph showing the light output vs the input electric current, of the laser diode according to the prior art.

### DESCRIPTION OF THE PREFERRED EMBODIMENT

Embodiments of the invention will now be described with reference to the accompanying drawings. The same reference numerals are used for elements having the substantially same function in the drawings and the specifications.

(First Embodiment)

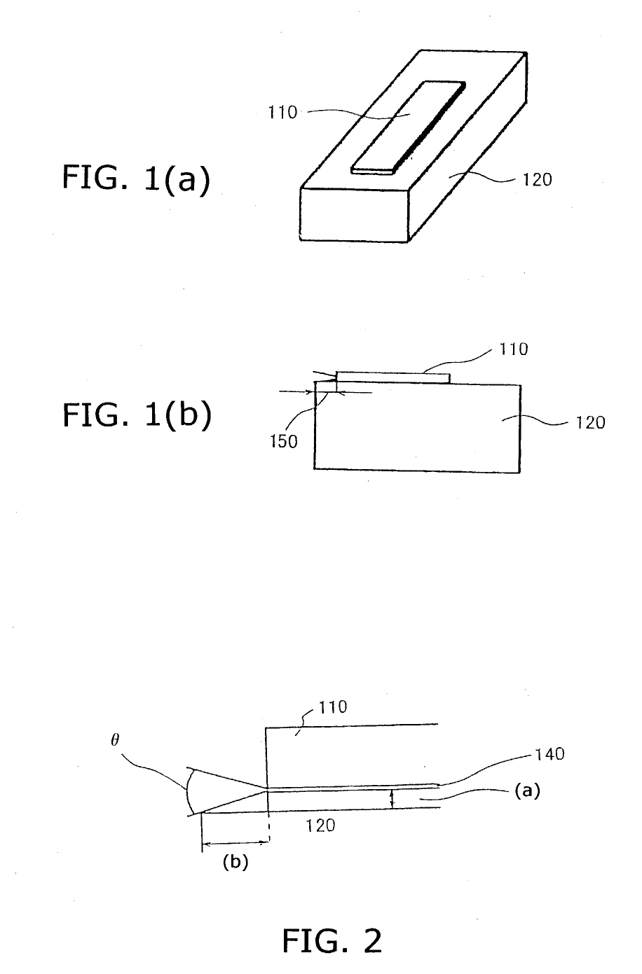

In FIG. 1, a laser diode chip 110 is disposed near the center of a sub-mount 120 instead of the side of the front face. As shown in FIG. 2, the maximum distance (b) between the front face of the sub-mount 120 and the front face of the laser diode chip 110, where an emitted beam is not blocked off by the sub-mount 120, is:

(b)=(a)/tan(θ/2)

wherein (a) is the height of an active layer 140 from the sub-mount 120 and θ is the angle of the spread of the emitted beam.

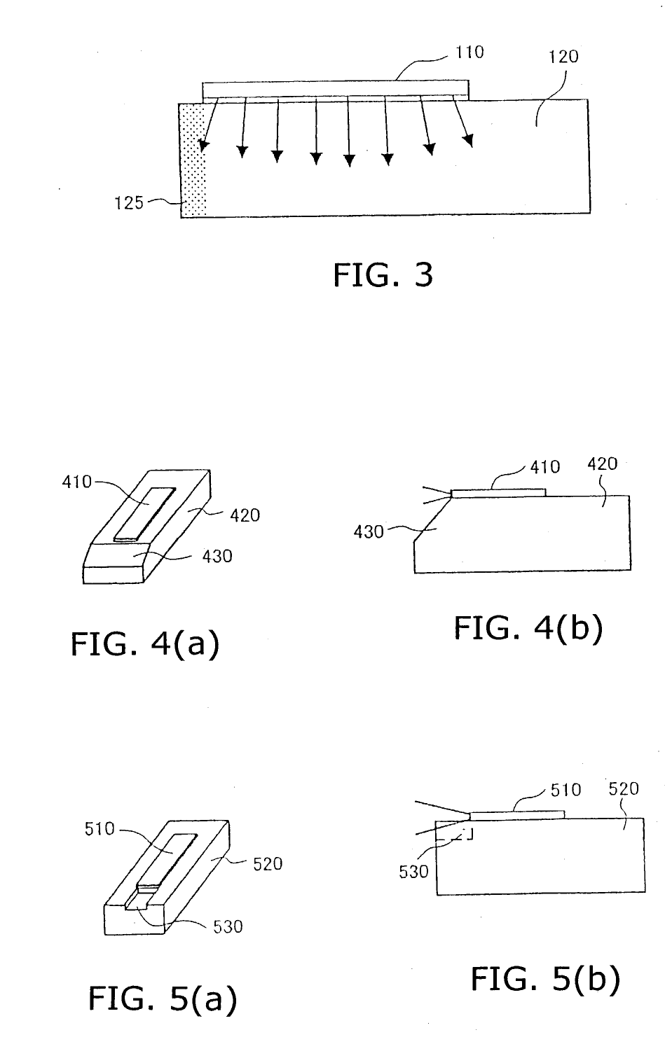

In FIG. 3, by moving the chip 110 to the side of the center of sub-mount 120 within the range of (b), heat generated in the front face area of the laser diode chip 110 is radiated via an end portion 125 of the sub-mount 120 so that the temperature in the front face area of the chip 110 rises less than that of the conventional method. Consequently, the heat radiation efficiency of the laser diode chip is increased so that the saturation of the light output in the range of high electric current is minimized, thus increasing the light output.

(Second Embodiment)

In FIG. 4, the sub-mount is provided with a taper 430 at the end face thereof on the side of the front face of the laser diode chip. The angle of the taper 430 is made larger than that of the extension of the beam from the laser diode chip. The angle and size of the taper 430 are dependent on the conditions of electric current and voltage applied to the chip and the material of the sub-mount, but it is preferable that they are determined so as to increase the radiation efficiency and avoid the output loss.

In the first embodiment, the position of the laser diode chip is restricted by the extension of the emitted beam. In the second embodiment, however, the laser diode chip can be moved closer to the center of the sub-mount than in the first embodiment because of the presence of the taper 430 provided in the sub-mount so that higher radiation efficiency is obtained. Consequently, the light output saturation is minimized in the range of high electric current so that the light output is increased.

(Third Embodiment)

In FIG. 5, the surface of the sub-mount is provided with a depression 530 in front of the front face of the laser diode chip. The shape and position of the depression 530 are dependent on the conditions of electric current and voltage applied to the chip and the material of the sub-mount; however, it is preferable that they are determined so as to increase the radiation efficiency and avoid the output loss.

The heat radiation efficiency of the third embodiment is higher than that of the second embodiment because the volume of the sub-mount portion before the front face of the laser diode chip is greater in the third embodiment than in the second embodiment. Accordingly, the light output is less saturated in the range of high electric current so that the light output is increased. In addition, the depression 530 is easier to make than the taper 430 in the second embodiment, thus reducing the manufacturing cost.

(Fourth Embodiment)

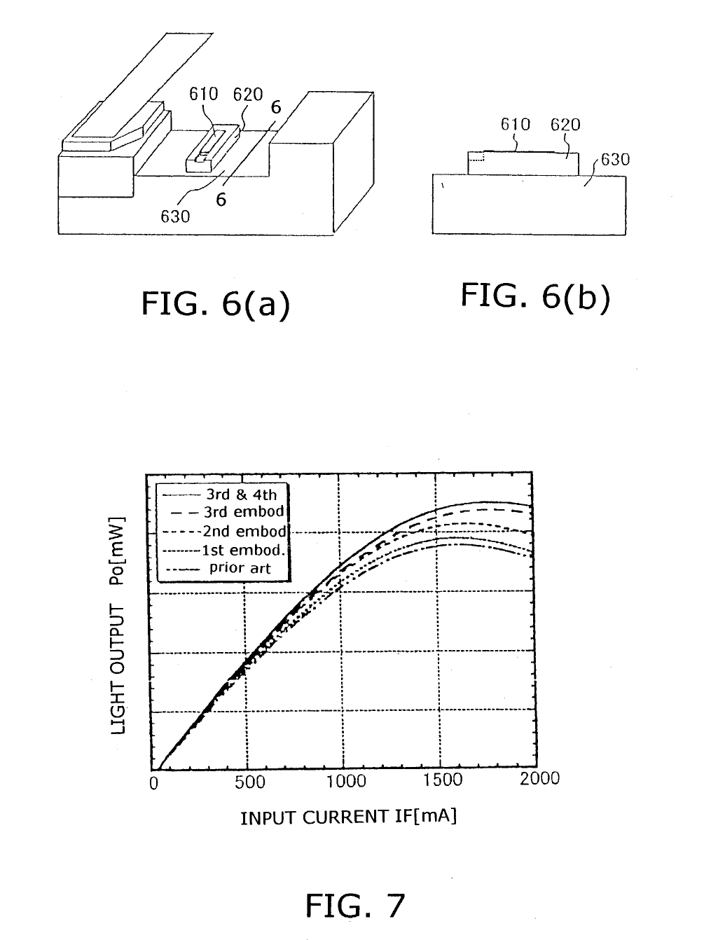

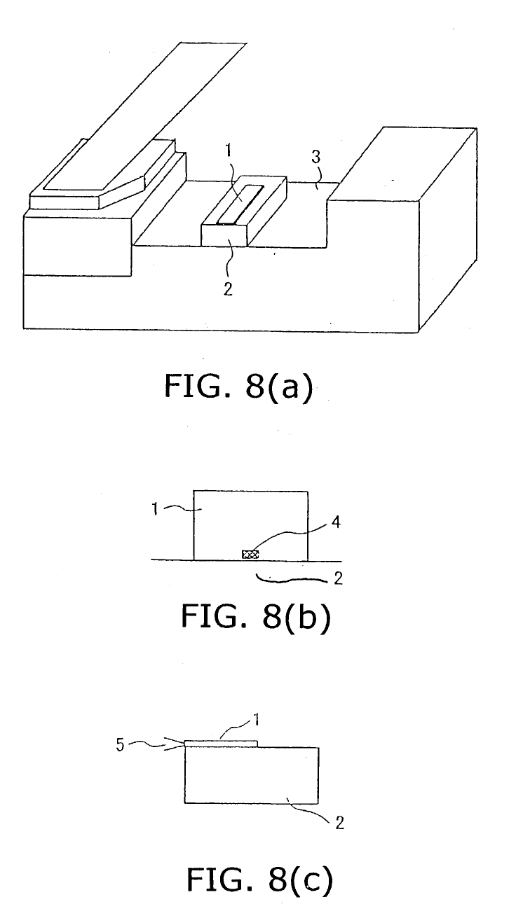

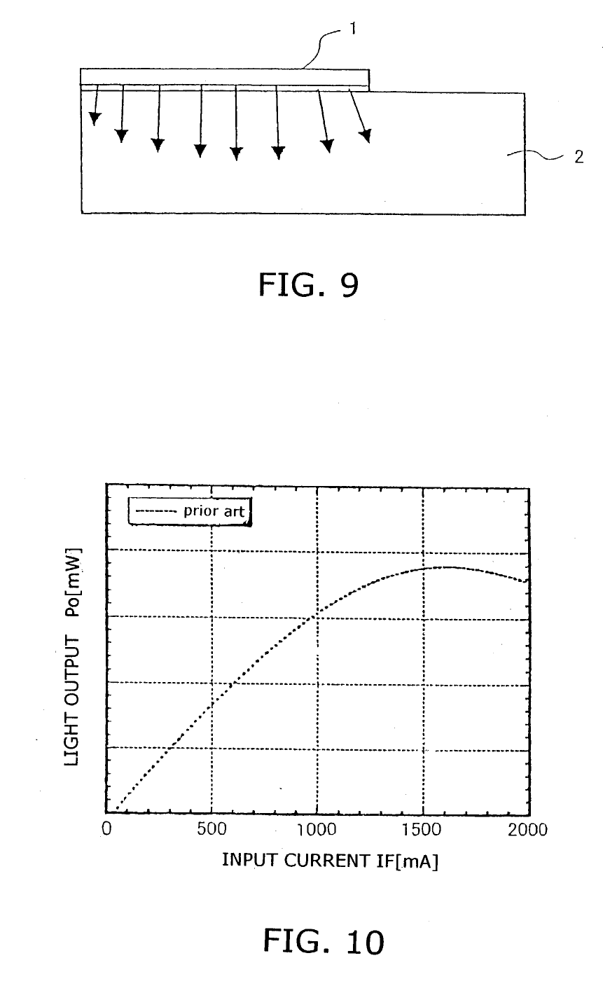

In FIG. 6, the sub-mount 620 is disposed near the center of the header 630 instead of the front end of the header 630. The position of the sub-mount 620 is dependent on the operation conditions of the laser diode, the materials of the sub-mount 620 and header 630, and the distance where the emitted beam can reach the lens or fiber without loss.

In the fourth embodiment, not only thermal conduction from the laser diode chip 610 to the sub-mount 620 but also thermal conduction from the sub-mount 620 to the header 630 is efficiently performed by moving the sub-mount 620 close to the center of the header 630. Accordingly, when the fourth embodiment is executed together with the first, second, or third embodiment, the saturation of the light output in the range of high electric current is minimized more efficiently and the light output is increased.

As shown in FIG. 7, the light output efficiencies according to the embodiments of the invention are better than that of the conventional method.

The invention is not limited to the embodiments described above. It is obvious that many modifications and variations of the present invention are possible in light of the above teachings for a person having ordinal skill in the art. Therefore, it is understood that such modifications and variations are within the scope of the present invention.

In the above embodiments, only the junction-down method is described, however, the invention is also applicable to the junction-up method. In the second embodiment, the taper of the sub-mount is made a straight line, however, it may be made curved as long as it does not block off the beam emitted from the laser diode chip.

According to the invention, the laser diode chip is disposed near the center of the sub-mount instead of the edge of the sub-mount such that the beam emitted from the laser diode chip is not blocked. Accordingly, the thermal conductivity is increased and the heat radiation efficiency is also increased, thus minimizing the increase of the temperature of the chip. Consequently, the saturation of the light output, which is caused by the heat generated in the chip when high electric current is applied, is minimized so that the light output is increased.

1. A laser diode comprising:
a header;
a sub-mount provided on an upper surface of said header; and
a laser diode chip provided in the vicinity of a center of said sub-mount and on an upper surface of said sub-mount.

2. The laser diode according to claim 1, wherein said laser diode chip is provided on said surface of said sub-mount such that a distance (b) between an edge on an output side of said sub-mount and a front face of said laser diode chip meets the formula, (b)<(a)/tan(θ/2), wherein said (a) is a distance between an upper surface of said sub-mount and a lower surface of an active layer of said laser diode chip and said θ is an angle of a spread in a vertical direction of a laser beam emitted from said active layer.

3. The laser diode according to claim 1, wherein a portion of said sub-mount in front of said front face of said laser diode chip is made tapered.

4. The laser diode according to claim 1, wherein a portion of said sub-mount in front of said front face of said laser diode chip is made depressed.

5. The laser diode according to claim 1, said sub-mount is provided on an upper surface of said header in the vicinity of a center of said header.

6. The laser diode according to claim 2, said sub-mount is provided on an upper surface of said header in the vicinity of a center of said header.

7. The laser diode according to claim 3, said sub-mount is provided on an upper surface of said header in the vicinity of a center of said header.

8. The laser diode according to claim 4, said sub-mount is provided on an upper surface of said header in the vicinity of a center of said header.
